(19) United States
(12) Patent Application Publication
(10) Pub. No.: US 2006/0144140 A1
(43) Pub. Date: Jul. 6, 2006

(54) Apparatus for external monitoring of the fluid level in a container

(76) Inventor: Yvon Hache, Dieppe (CA)

Correspondence Address: STORM L.L.P., BANK OF AMERICA PLAZA, 901 MAIN STREET, SUITE 7100, DALLAS, TX, 75202, US

(21) Appl. No.: 10/516,240

(22) PCT Filed: Jun. 27, 2003
(86) PCT No.: PCT/CA03/00916

§ 371 Date: Jan. 27, 2006

(30) Foreign Application Priority Data
Jun. 28, 2002 (CA) 2392519

(51) Int. Cl. G01F 23/00

(52) U.S. Cl. 73/295

(57) ABSTRACT

The present invention provides an apparatus for monitoring the fluid level in a container comprising a carrier means adapted to be fitted and secured to a container. At least one sensing means is located within the carrier means; each sensing means is adapted to collect characteristics relating to the container wall. The characteristics being proximate to the sensing means location on the container. A display device is provided on the carrier means in order to indicate the fluid level within the container. A processing system is adapted to collect information from the sensing means and upon the processing of this information, the processing system transmits control signals to the display device in order to indicate the fluid level in the container.

### FIELD OF THE INVENTION

The present invention pertains to the field of sensing devices and more particularly, to a fluid indicator device for establishing the amount of fluid remaining in a container.

### BACKGROUND

In the field of containers and more specifically for propane tanks, there are a number of systems known for estimating the remaining propane contents of the tank. See, U.S. Pat. Nos. 5,555,764; 4,688,028; 4,507,961; D283,988. Another system provides a visible temperature indicator, in the form of a liquid crystal strip, having a visible transition temperature of about 40-60° F. When in use, the propane in the tank volatilizes to supply the external device, which is typically a burner. While volatilizing, the propane self-cools by the heat of vaporization. Thus, the temperature of the liquid portion drops, while the gaseous portion remains undisturbed and would also attain the same temperature. The external environment supplies heat, which is transmitted through the tank wall, wherein, the lower heat capacity of the gaseous propane causes it to heat at a quicker rate than the liquid propane. Since the tank wall has a finite heat capacity and thermal conductance, there will be a temperature transition demarcation on the wall of the tank at the liquid-gas junction. A liquid crystal sensing strip will have a color change at this level, allowing visible indication of the liquid level within the tank.

These systems, however, require sufficient thermal contact between the liquid crystal strip and the tank. In addition these systems only identify a demarcation after the tank has been operative for a period of time. Furthermore, these strips have a limited operating range thus environmental conditions, for example, temperature, moisture, or radiant heat may reduce their effectiveness.

Other types of content level gages which are in use include weight or mass sensors and floats. These forms of content level gages may require numerous components and/or modifications to the inside or outside of a tank in order to provide the desired functionality. Some systems also measure pressure variation but only identify a demarcation after the tank has been operative for a period of time. This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide an apparatus for monitoring fluid level in a container. In accordance with an aspect of the present invention, there is provided an apparatus for monitoring the fluid level in a container comprising a carrier means adapted to be fitted and secured to a container. At least one sensing means is located within the carrier means; each sensing means is adapted to collect characteristics relating to the container. The characteristics being proximate to the sensing means location on the container. A display device is also located on the carrier means to indicate the fluid level within the container and a processing system is adapted to collect data from the sensing means and to send control signals to the display device to control activation of the display device and a power source is electrically connected to the sensing means, display device and the processing means.

### BRIEF DESCRIPTION OF THE FIGURES

FIG. 1 is a front view of one embodiment of the present invention.

FIG. 2 is a side view of a propane tank having one embodiment of the present invention attached to it.

FIG. 2a is a front view of the display device in one embodiment of the present invention.

FIG. 3 is a flow chart of steps performed by the processing system according to one embodiment of the present invention.

### DETAILED DESCRIPTION OF THE INVENTION

Definitions

The term “Carrier Means” is used to define a medium which encompasses the sensing means, processing system and display device are connected, according to the present invention. For example, a carrier means may be a flexible or rigid strip of material that may be attached to a container or a tank by glue, magnets or any other means as would be known by a worker skilled in the art.

The term “Sensing Means” is used to define components capable of measuring various characteristics of a container. Such characteristics may be the container's wall temperature or the container's wall acoustic. The components utilized to measure these characteristics may be defined as diodes, transistors, thermocouples, thermistors, semiconductors or any other appropriate measuring devices as would be known by a worker skilled in the art.

The term “Display Device” is used to define a display which indicates the level of fluid within a container. For example, the display device may be defined as a liquid crystal display, digital display, electronic ink, electronic paper or light emitting diodes or any other appropriate device as would be known by a worker skilled in the art.

The term “Processing System” is used to define an electronic circuit which obtains measurement readings from the sensing means operatively associated with a container and subsequently evaluates the fluid level within the container and controls the display means.

Unless defined otherwise, all technical and scientific terms used herein have the same meaning as commonly understood by one of ordinary skill in the art to which this invention belongs.

The present invention provides an apparatus for monitoring the fluid level in a container which comprises a carrier means attached to the container. Sensing means, a processing system and display device are operatively associated with the carrier means. The sensing means enables the measurement of various characteristics of the container for example, temperature and/or acoustic properties. The processing system determines the level of fluid in the container by monitoring measurements obtained from the sensing means. The display device is an indicator representing the fluid level in the container. The processing system is operatively associated with the display means and based on the measurement readings from the sensing means the processing system sends control signals display device in order that it displays the fluid level within the container.

Carrier Means

In one embodiment of the present invention, the carrier means is defined as a piece of rigid or flexible material to which sensing means, a display device and a processing system may be fixed. In one embodiment, the carrier means may be attached to the container in a vertical or horizontal fashion. In one embodiment of the present invention, the carrier means may be composed of nylon, cloth, metal (thin), plastic, rubber, vinyl or a polymer or any other material as would be known by a worker skilled in the art. The carrier means may also have flexible and non-deteriorating properties as the carrier means may exposed to various weather conditions. The carrier means is required to have isolating properties, i.e., enabling to have sensors embedded within the carrier means such that the sensing means are isolated or protected from the elements or the environment in order to assure their functionality. The carrier means must also enable wiring to be embedded within it in order to relay information detected by the sensing means to the processing system. The wiring integrity is required in order to assure the functionality of the apparatus of the present invention. In one embodiment, the sensing means are operatively connected to the processing system through wiring embedded in a carrier means fabricated from a mylar material. The mylar material may also be covered with a protective film in order to provide or increase the environmental resistance of the apparatus. This protective cover can be in a form of a spray or sheath, however the protective cover must be compatible with the material from which the carrier means is manufactured. For example a polymer spray can be used as the protective cover for a mylar type material.

Container Types

In one embodiment, the carrier means of the present invention may be applied to various types of containers having different sizes by increasing or decreasing the length of the carrier means. For example such containers could be propane containers, diesel containers, gasoline containers, septic containers, or any other fluid container as would be known by a worker skilled in the art. Through such modifications of the carrier means, the number of sensing means may be increased or decreased and strategically placed thereon, such that the fluid level in a variety of containers can be determined. The exact distance between each sensing means may also have an impact on the accuracy of the apparatus of the present invention.

In another embodiment, the carrier means could be applied to a container defined as a pipe in order to display the actual level of fluid within the pipe. In this example, the device can be applied to the pipe along its width, thereby enabling the determination of the fluid level therein.

In one embodiment, the carrier means may be applied to containers containing various types of fluid for example propane, gasoline, water, oil or any other fluid which may be stored within any type of container as would be known by a worker skilled in the art.

Sensing Means

In one embodiment of the present invention, the sensing means may be defined as temperature sensors which measure a container's wall temperature. The temperature sensors will determine the various temperatures on the container's wall as the thermal conductivity of the fluid, for example in a liquid state, will be higher than the thermal conductivity of the fluid in a gaseous state, i.e. empty portion of the container. All sensors are interconnected to the processing means such that the collected information can be transmitted to the processing system. The wiring used to relay each sensor is any wiring as would be known by a worker skilled in the relevant art for such an application. In on embodiment, the wiring used to relay the collected information from the sensing means to the processing system can be configured such that a multiplexer can be used. In one embodiment, each sensor has a commonly wired anode and each sensor has a distinct cathode thereby enabling uniform excitation of the sensors and individual detection of the information from the sensor, for example. In one embodiment, if the external temperature drops, the fluid temperature in a liquid state may be higher then the fluid temperature in the gaseous state and as such a sensing device may be used in order to account for this scenario and as such the processing system can still be able to determine the liquid level in a container independent of the external temperature.

In one embodiment of the present invention, the sensing means are temperature sensors which are diode sensors that measure the temperature through the DC voltage drop across a diode. A temperature reading is possible since the temperature increases the voltage drop across the diode decreases. The use of diode sensors as the sensing means enables the manufacture of the apparatus according to the present invention at a relatively low cost, when having regard to alternate temperature sensors, for example thermocouples.

In another embodiment of the present invention, the sensing means are temperature sensors which are resistance temperature detectors (RTD). Such sensors are resistors wound from platinum wire and measure 100 Ohms when at 0 degree Celsius. The resistance of the sensor increases as temperature rises and the measurement of the resistance provides a means for determining the temperature.

In another embodiment of the present invention, the sensing means may be defined as an acoustic sensor or acoustic sensor array used to produce acoustic waves, which characteristically differ based on the fluid level. For example, a linear array of piezoelectric elements rest against the container wall. One or more elements of the array are excited, for example in a pulse or chirp waveform, and each of the sensors “listens”. Due to the differences in the acoustic properties of a liquid with respect to a gas, the sensors will have outputs which may distinguish a liquid level. Alternately, an acoustic transducer excites a wave in the wall of the tank, which travels down the side the tank. At the liquid level, an impedance mismatch occurs and a portion of the wave is reflected. The characteristic timing of the reflection is determined, as is well known in the field of time domain reflectometry. The sensor control may be, for example, an adaptive control, and thus need not be separately calibrated for every fluid container.

In another embodiment, the sensing means may be active or passive, and operate by determining thermal or acoustic characteristics of the tank.

In another embodiment, the sensing means may be conditioned and multiplexed by a multiplexer/signal conditioner prior to digitization in the ADC.

In another embodiment, the sensing means may have any number of temperature or acoustic sensors. For example, the number of sensors could be limited to only two along the length of the carrier means. Alternatively, there may be a plurality of sensors positioned on the carrier means wherein the greater the number of sensors, the more accurate the fluid level may be determined.

The power source for such sensors is provided by a battery positioned in electrical contact with the processing system, for example. The size of the battery used is directly linked to the size of the carrier means and as such the size of the device. Larger devices may enable batteries of a greater size or capacity to be used. Another source of power may be generated through solar radiation as fluid containers are generally stored outside. The solar radiation would be collected by solar panels on the carrier means and converted into electrical power for use by the device.

Display Device

In one embodiment of the present invention, the display means may be defined as a liquid crystal display, digital display, electronic ink or electronic paper, or light emitting diodes or any other appropriate device as would be known by a worker skilled in the art. The display means is also constructed to withstand exposure to weather conditions and to minimise energy consumption which may be under the control of the processing system. The display means may also be powered by battery or solar energy as described above.

In one embodiment of the invention, the display device is divided into a plurality of divisions wherein as each division is illuminated it indicates the proportion of the tank that contains fluid. For example, if the display device is divided into four areas, by illuminating three of these areas will indicate that the tank is three quarters full, for example. The number of divisions within the display device can be directly related to the level of accuracy which can be determined by the processing system which can be related to the number of sensing means associated with the apparatus.

Processing System

The processing system collects information from the sensing means and calculates the level of the fluid within the container based on this information. Upon the identification of the level of the fluid within the container, the processing system sends control signals to the display device such that it will display the calculated level within the container. The accuracy of the level of a fluid within a container can be dependent on number of sensing means from which the processing means collects information. In addition, if the display device is separated into few regions of potential illumination the level of accuracy thereof may be limited as well.

In one embodiment of the present invention, the processing system may provide sensor excitation and signal conditioning circuits for each sensor system, a digitizer, for converting analog sensor signals to digital values, a micro-controller, having non-volatile program memory, volatile working memory, and persistent memory for adaptive parameters. The processing system may also receive user input to control the operation and produce outputs including audible and visible alarms. The processing system may be battery powered, and is preferably intrinsically safe, meaning that, even with a fault condition, it will not be capable of igniting a combustible gas in the environment. This intrinsic safety can be achieved by the avoidance of energy storage elements configured to provide spark energy which may ignite a flame, or through the use of flame arresters, for example.

In another embodiment, the processing system may store a program in read only memory (ROM). The processing system may operate by using temporary storage in registers and random access memory (RAM). Sensor calibration data, as well as environmental factors and data about the container may be periodically stored and updated in electrically erasable programmable read only memory (EEPROM).

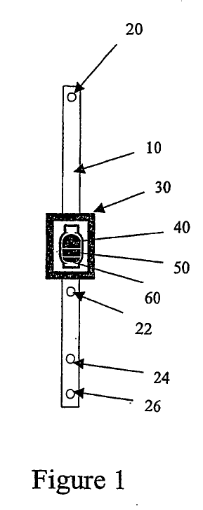

In one embodiment and with reference to FIG. 1, the carrier means 10 is defined as an elongated strip of material which may have individual magnets inserted within it at strategic locations. The sensing means comprises four sensors 20, 22, 24, and 26 which are strategically positioned to measure the wall temperature of a fluid container. In one embodiment, the individual magnets may be strategically positioned within or on the surface of the carrier means to ensure that the sensors are in contact with the container wall. In another embodiment, the individual magnets may be positioned underneath the sensors as magnetic sensors are made of steel and enable heat to radiate to the sensors unobstructed. The display device is shown as an LCD display 30 with an image of a propane container. The LCD display 30 has three illuminating sections such as a top illuminating section 40, a middle illuminating section 50 and a bottom illuminating section 60. For example, the illumination of all three illuminating sections indicates that the container level is full. The illumination of the middle illuminating section 50 and the bottom illuminating section 60 indicates that the container is half full. The illumination of only the bottom illuminating section 60 indicates that the container is almost empty and the container should be refilled. In another embodiment, the display device may flash when the level of fluid within the container is very low, in this manner there is a form of a visual alarm, thereby indicating that the container is to be refilled.

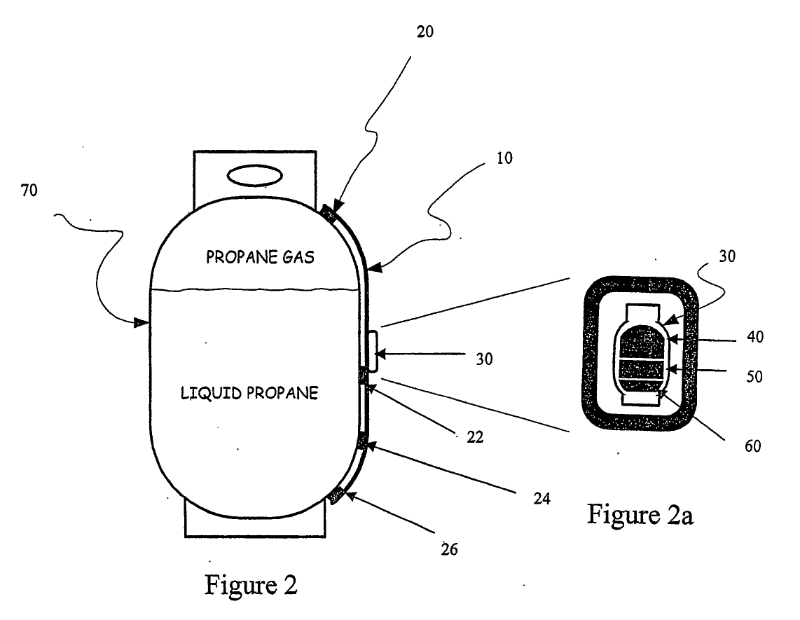

In one embodiment of the present invention and with reference to FIG. 2, the carrier means 10 is secured to a propane tank 70 through the use of the magnetic properties of the carrier means 10. Sensing means such as a form of temperature sensors are positioned on the magnetic carrier means 10. A first temperature sensor 20 is positioned at the upper portion of the tank. A second temperature sensor 22 is positioned near the central portion of the tank. A third temperature sensor 24 is positioned near the bottom portion of the tank and a fourth temperature sensor 26 is positioned at the bottom of the tank. The bottom sensor 26 is considered as the base reference since this section of the container generally has fluid in contact with the walls of the container at all times. If the fluid reaches a level lower than sensor 26 then the container is empty and requires to be filled. The LCD display 30 is positioned at the middle portion of the tank. A processing means defined as an electronic circuit is contained within the carrier means 10 and reads the temperature measurement from each temperature sensors. Upon reading the temperature from each temperature sensors, the electronic circuit determines the level of the propane within the tank and controls the display means such that the appropriate fluid level is displayed on the LCD display 30. The level of propane can be determined through comparison of the various temperatures measured by the temperature sensors and may be subsequently compared with stored data indicating the level of propane within the tank based on previous temperatures readings from the temperature sensors.

In one embodiment, the level of propane in the tank is displayed in a continuous fashion even after the propane tank is not in use. However, in order to conserve energy within the battery for example, an activation button can be integrated onto the carrier means and upon the depression of the button the level of the fluid in the container would be displayed. A worker skilled in the art would understand that the number of temperature sensors located within the magnetic strip can be varied depending on the accuracy required. For example, the greater the number of sensors, the more accurate the fluid level within a container may be determined.

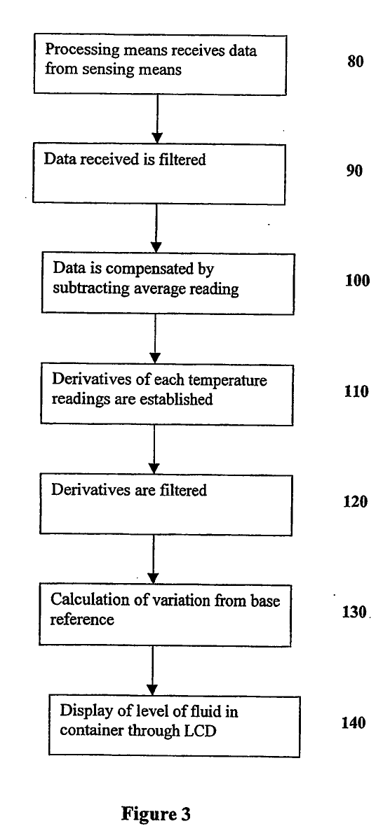

In one embodiment of the present invention and with reference to FIG. 3, as a first step 80, the processing means receives readings from the sensing means. The data received is filtered to remove any data which may be faulty at step 90. A worker skilled in the relevant art would understand how to transform such data into temperature readings if required and this would be dependent on the type of sensing means being used. At step 100, the temperature readings are then compensated for various parameters wherein the average reading from each sensor is subtracted from each reading. Other factors could also be considered namely, environmental factors, ambient temperature fluctuations between each temperature readings of each sensor, tank location, or any other factor as would be known by a worker skilled in the relevant art. Derivatives of all temperatures readings are executed at step 110 in order to minimise the offset between all sensor readings present on the carrier means. At step 120 the derivatives are filtered and at step 130 used to calculate the variation between each sensor with respect to the base reference sensor as described above. A worker skilled in the relevant art would understand how to use such data and determine the level of a fluid in a container. The display means is then adjusted at step 140 if required to show the level of fluid in the container. Prior to recording readings from the sensors, the updating of the display device is executed when a temperature drop of the base sensor is detected which represents the depletion of the fluid within the tank, for example a gas barbeque is being used.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

I claim:

1. An apparatus for monitoring the fluid level in a container comprising:
a) a carrier means adapted to be fitted and secured to said container;
b) at least one sensing means located within said carrier means; each sensing means is adapted to collect characteristics relating to said container; said characteristics being proximate to said sensing means location on container;
c) a display device located on said carrier means to indicate fluid level within said container; and
d) a processing system adapted to collect data from said sensing means and send control signals to said display device to control activation of the display device
wherein a power source is electrically connected to the sensing means, display device and the processing means.

2. The apparatus of claim 1 wherein the carrier means is fabricated from a fiber material.

3. The apparatus of claim 1 wherein the carrier means is fabricated from a mylar material.

4. The apparatus of claim 3 wherein the carrier means is covered with a polymer sealant.

5. The apparatus of claim 1 wherein the carrier means has an adhesive layer on one side in order to adhere to the container.

6. The apparatus of claim 1 wherein the carrier means has magnets on one side in order to adhere to the container.

7. The apparatus of claim 1 wherein the sensing means is one or more diode sensors.

8. The apparatus of claim 6 wherein a first diode sensors is positioned at the top of the container and a second diode sensor is positioned at the bottom of the container.

9. The apparatus of claim 1 wherein the sensing means is one or more RTD sensors.

10. The apparatus of claim 1 wherein the processing means is a micro-processor.

11. The apparatus of claim 1 wherein the display means is an LCD display.

12. The apparatus of claim 1 wherein a power source is under the form of a battery.

13. The apparatus of claim 1 wherein activation buttons are positioned on the carrier mean in order to active the apparatus.
